(19) United States
(12) Patent Application Publication
(10) Pub. No.: US 2008/0102429 A1
(43) Pub. Date: May 1, 2008

(54) Online study abroad office

(76) Inventor: Antonis Polemitis, New York, NY (US)

Correspondence Address: LESTER H. BIRNBAUM, 6 OAKMOUNT COURT, SIMPSONVILLE, SC, 29681, US

(21) Appl. No.: 11/977,626

(22) Filed: Oct. 25, 2007

Related U.S. Application Data
(60) Provisional application No. 60/855,100, filed on Oct. 26, 2006.

(51) Int. Cl. G09B 5/00

(52) U.S. Cl. 434/322

(57) ABSTRACT

The present invention provides a method, a system and a computer program product for providing study abroad assistance and information in a computer network. The study abroad assistance and information is customized and prioritized according to the needs and requirements of a plurality of home universities. The customized and prioritized study abroad assistance and information is provided by creating a plurality of customized study abroad office websites for the plurality of home universities. The plurality of study abroad office websites are customized and prioritized, according to the information provided by administrators of the plurality of home universities.

### CROSS REFERENCE TO RELATED APPLICATION

This application claims the benefit of co-pending provisional patent application No. 60/855,100 filed Oct. 26, 2006, which is incorporated by reference herein.

### BACKGROUND

The invention relates to the field of providing assistance to students of home universities for study abroad programs. More specifically, the present invention relates to providing study abroad assistance and information to students of home universities in selecting and enrolling for study abroad programs.

Studying abroad is an act of a student of a home university pursuing a study abroad program in a host university which is situated in a different geographical location, such as a foreign country. A host university is a provider or institution which host study abroad programs, which might not be always be a university. A home university is an institution whose student goes on to pursue a study abroad program in a host university which is a program provider who hosts one or more study abroad programs. The duration of these study abroad programs may vary from one week to an academic year. The students usually pursue study abroad programs for earning credits that are transferable to higher education institutions in the home country of the student.

Students of home universities are provided with assistance and information about the various study abroad programs that are offered by one or more host universities. For this, some of the home universities have their own study abroad offices, which provide assistance and information to their students for pursuing various study abroad programs in one or more host universities. Some of the host universities located in different geographical locations have formed consortiums for providing assistance and information. In addition to these, there are many third party service providers that help students to pursue study abroad programs.

However, the existing solutions do not provide study abroad assistance and information that is customized and prioritized according to the needs and requirements of the home universities or the students of the home universities. Further, there is no common platform for the interaction between the one or more home universities and the one or more host universities. In addition, the students of the one or more home universities have limited options to select the study abroad programs.

Hence, there exists a need for a method, a system and a computer program product for providing study abroad assistance and information which is customized and prioritized according to the needs and requirements of home universities and/or students of the home universities. Further, the method, system and computer program product should provide a common platform for the interaction between the plurality of home universities and a plurality of host universities.

### SUMMARY

It is an object of the present invention to provide study abroad assistance and information to one or more students of a plurality of home universities in a computer network which is customized and prioritized according to the needs and requirements of the plurality of home universities.

It is another object of the present invention to provide study abroad assistance and information to the one or more students of the plurality of home universities in the computer network which is customized and prioritized according to the needs and requirements of the one or more students of the plurality of home universities.

It is yet another object of the present invention to provide a common platform for the interaction between the plurality of home universities and a plurality of host universities for providing study broad assistance and information to the one or more students.

It is still another object of the present invention to create a plurality of customized study abroad office websites for the plurality of home universities. The plurality of customized study abroad office websites are linked to a central database for providing customized and prioritized study abroad assistance and information to the one or more students of the plurality of home universities. The customized and prioritized study abroad information comprises information about a list of study abroad programs. The list of study abroad programs is a sub set of various study abroad programs information stored in the central database.

In view of the foregoing discussion, the present invention provides a method, a system and a computer program product for providing customized and prioritized study abroad assistance and information to the one or more students of the plurality of home universities in a computer network. The customized study abroad information is provided by creating the plurality of customized study abroad office websites for the plurality of home universities in the computer network.

According to the method, a central database is maintained for storing information about various study abroad programs offered by the plurality of host universities. The central database further contains information about both the plurality of home and host universities. Each of the plurality of host universities host one or more study abroad programs either individually or in collaboration with other host universities. The central database is updated with the latest information about the various study abroad programs through a main administrator interface. One or more central administrators of the central database update and manage the information stored in the central database. A plurality of study abroad office websites customized for the plurality of home universities are created by the one or more central administrators through a plurality of website modules. The plurality of website modules is connected to the central database. Each of the plurality of website modules is further connected to a plurality of university administrator interfaces of the plurality of home universities for customizing the plurality of study abroad office websites. One or more university administrators of the plurality of home universities use the plurality of university administrator interfaces for providing information about their home university to the central database. Further, the one or more university administrators use their university administrator interface for managing accounts of their one or more students in their study abroad office website.

### BRIEF DESCRIPTION OF THE DRAWINGS

The exemplary embodiments of the invention will hereinafter be described in conjunction with the appended drawings provided to illustrate and not to limit the invention, wherein like designations denote like elements, and in which:

FIG. 1 is a block diagram of a system for providing study abroad assistance and information customized and prioritized according to the needs and requirements of a plurality of home universities in a computer network, in accordance with an embodiment of the present invention;

FIG. 2 is a flowchart of a method for providing customized study abroad information to students of a plurality of home universities, in accordance with an embodiment of the invention;

FIG. 3 is a screenshot of a webpage illustrating a login account of a student of a home university, in accordance with an embodiment of the present invention;

FIG. 4 is a screenshot of a webpage illustrating a university administrator login page of a study abroad office website of a home university, in accordance with an embodiment of the present invention; and

FIG. 5 is a screenshot of a webpage illustrating a central administrator login page of a central administrator in a central website, in accordance with an embodiment of the present invention.

### DETAILED DESCRIPTION OF THE INVENTION

The present invention provides a method, a system and a computer program product for providing study abroad assistance and information in a computer network, which is customized and prioritized according to the needs and requirements of a plurality of home universities. The customized and prioritized study abroad assistance and information is provided by creating a plurality of customized study abroad office websites for the plurality of home universities. The plurality of study abroad office websites are customized and prioritized according to the information provided by administrators of the plurality of home universities.

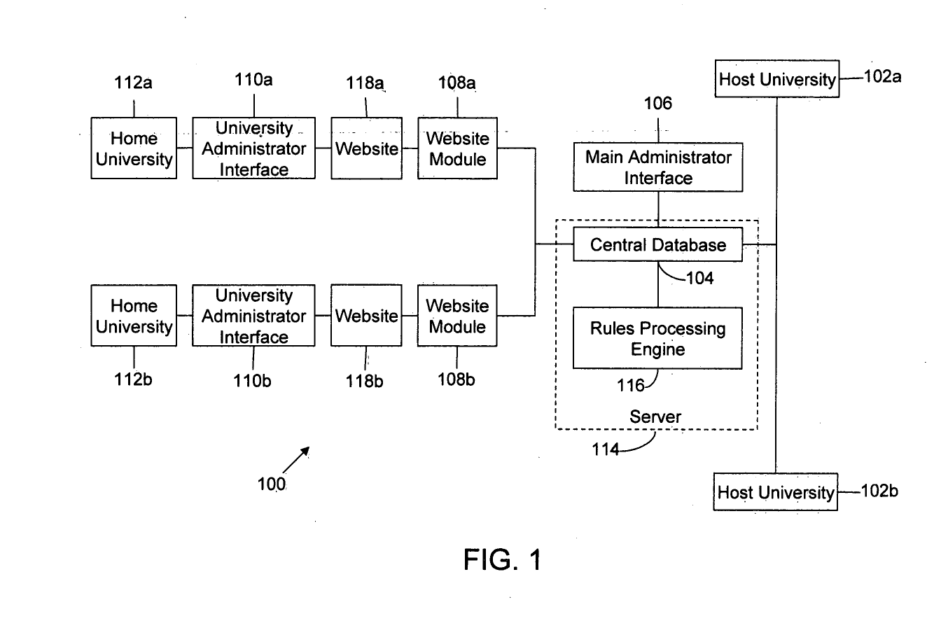

FIG. 1 is a block diagram of a system 100 for providing study abroad assistance and information customized and prioritized according to the needs and requirements of a plurality of home universities in a computer network, in accordance with an embodiment of the present invention.

A home university is an institution whose students go on to pursue a study abroad program in a host university. The host university is a program provider that hosts one or more study abroad programs either individually or in collaboration with other host universities. The host university is a provider or institution which host study abroad programs, which might not be always be a university. In accordance with the invention, the same university can act as both a home university as well as a host university.

System 100 includes a plurality of host universities, such as host universities 102a and 102b that host one or more study abroad programs either individually or in collaboration with other host universities. Host universities 102a and 102b are connected to a central database 104 for providing to central database 104 information regarding one or more study abroad programs which they host. The information provided by host universities is stored and maintained by one or more central administrators of central database 104 through a main administrator interface 106. The one or more central administrators further update the information stored in central database 104 with the latest information provided by host universities 102a and 102b. In accordance with the invention, more than one central database may be used for storing study abroad information.

Central database 104 is connected to a plurality of website modules, such as website modules 108a, and 108b for creating customized study abroad office websites, such as websites 118a, and 118b for a plurality of home universities, such as home universities 112a and 112b. One or more university administrators of each of home universities 112a and 112b provide information to websites module 108a and 108b through corresponding university administrator interfaces, such as university administrator interfaces 110a and 110b. For example, one or more university administrators of home university 112b will provide information to website module 108b through university administrator interface 110b. The information provided by the one or more university administrators of the plurality of home universities is used for customizing the study abroad office websites 118a and 118b of home universities 112a and 112b.

Host universities 102a and 102b are connected to the central database 104 for providing to central database 104 information regarding one or more study abroad programs which they host. The one or more study abroad programs usually run for a time duration varying from a few weeks to a year. Examples of study abroad information include, but are not limited to, admission requirements, eligibility requirements, admission and enrollment documents, application forms, dates and deadlines, fees and fee components, geographical location details of the host university, list of affiliated study abroad programs, contact person details, details about host universities, courses offered by each of the host universities, information about countries of host universities, information about cities of host universities, housing and lodging options available, on-site support, travel and excursions, emergency contacts and procedures and other information pertaining to study abroad programs and universities.

Host universities 102a and 102b access and provide study abroad information to central database 104 for storage therein by using their respective university websites 118a and 118b. The study abroad information provided by host universities 102a and 102b is stored in central database 104. The one or more central administrators store the study abroad information in central database 104 through main administrator interface 106. The one or more central administrators further maintain and update the study abroad information stored in central database 104 through main administrator interface 106. In accordance with an embodiment of the present invention, host universities 102a and 102b are provided with accounts for updating the study abroad information in central database 104 corresponding to the study abroad programs offered by them. The study abroad information is regularly updated in central database 104 for providing right and complete information to the plurality of home universities.

Central database 104 is hosted on a server 114 (shown by dotted box in FIG. 1) connected to a computer network (not shown in FIG. 1). The computer network is a web of interconnected computational devices. Examples of computer networks include, but are not limited to, wide area networks (WAN), local area networks (LAN), metropolitan area networks (MAN), campus area networks, personal area networks and wireless local area networks (WLAN). Examples of computational devices include, but are not limited to, palmtops, laptops, personal computers, main frame computers, super computers and personal digital assistants (PDAs). The computational devices are connected in one or more network topologies, such as ring topology, star topology, mesh topology and tree topology. The computational devices are connected through various communication channels in one or more network topologies. Examples of communication channels include, but are not limited to, wired communication channels, wireless communication channels and optical fiber communication channels.

In an embodiment of the present invention, central database 104 is hosted on a central server which is connected to the Internet. The plurality of host universities access and provide study abroad information to central database 104 by using various protocols normally used for information exchange over the Internet, such as transmission control protocol (TCP), internet protocol (IP), hypertext transfer protocol (HTTP) and file transfer protocol (FTP). The one or more university administrators of each of the plurality of home universities access study abroad information stored on central database 104 using the above listed protocols.

Central database 104 further stores profile information about students of the plurality of home universities. Examples of profile information include, but are not limited to, educational qualifications of students, bio-data/resumes of students, interests/hobbies of students, information regarding academic achievements of students, disciplinary records of students, projects undertaken by students, trainings undergone by students, workshops attended by students, extra curricular activities of students, applications submitted by students and status of the various applications submitted by students. In accordance with an embodiment of the present invention, one or more students of a plurality of home universities are provided with login accounts in the study abroad office websites created for their home universities. The one or more students use their login accounts for uploading, updating and/or viewing their profile information.

Central database 104 is connected to a rules processing engine 116, which is also hosted on the server, as shown in FIG. 1. Rules processing engine 116 is a computer program that runs on the information stored in central database 104 for scoring the one or more applications submitted by the one or more students of the plurality of home universities. Rules processing engine 116 scores the one or more application based on the eligibility requirements of the study abroad programs and/or predefined criteria. The predefined criteria may include admission criteria or any other criteria defined by host universities 102a and 102b for admission into the study abroad programs offered by them. The one or more applications of the students are recommended to host universities 102a and 102b based on the scoring provided by rules processing engine 116. In accordance with an embodiment of the present invention, rules processing engine 116 is used for screening one or more applications submitted by the students. In an embodiment of the present invention, rules processing engine is customizable by the one or more university administrators of the plurality of home universities through their university administrator interfaces.

The study abroad information available in central database 104 is provided to home universities 112a and 112b by creating customized study abroad office websites 118a and 118b, which are dynamically and automatically created by website modules 108a and 108b.

In accordance with an embodiment of the present invention, a website module dynamically and automatically creates a study abroad office website for a home university using programming languages, such as javascript, html, XML, PHP and other suitable programming languages. The javascript or other suitable methods and the webpages of the created study abroad office website are dynamically generated and displayed from central database 104. The study abroad office website thus created for a home university is not a static website in html. All the formatting and program options are created “on the fly” based on the customized options of the home university module relating to which host universities they have selected and how they have customized the look, feel and format of their own website.

In accordance with another embodiment of the present invention, a website module creates a study abroad office website via a subdomain of the website of a home university. The subdomain is redirected to central database 104. For example, http://www.abroad.wvu.edu will be the IP address for such a study abroad office website, where the study abroad office website is created as a subdomain of the website of the home university (http://www.wvu.edu).

In accordance with still another embodiment of the present invention, a website module creates a study abroad office website via a subdomain of the central website which is hosted on the server of central database 104. For example, http://wvu.abroadoffice.net will be the IP address for such a study abroad office website, where the study abroad office website is created via a subdomain of the central website (http://www.abroadoffice.net).

In accordance with yet another embodiment of the present invention, a website module creates a study abroad office website via a webpage on the central website which is hosted on the server of central database 104. For example, http://www.abroadoffice.net/wvu.html will be the IP address for such a study abroad office website, where the study abroad office website is created via a webpage of the central website (http://www.abroadoffice.net).

Website modules 108a and 108b automatically and dynamically create the customized study abroad office websites 118a and 118b based on the information provided by the one or more university administrators of home universities 112a and 112b. The one or more university administrators of home universities 112a and 112b provide information to website modules 108a and 108b through university administrator interfaces 110a and 110b. University administrator interfaces 110a and 110b provide the interface to the one or more university administrators of home universities 112a and 112b to create customized study abroad office websites 118a and 118b in which the information is customized and prioritized according to the needs and requirements of home universities 112a and 112b. For example, the one or more university administrators of home university 112a may use university administrator interface 110a for customizing the study abroad office website 118a created for home university 112a. University administrator interfaces 110a and 110b enable creation of customized study abroad office websites 118a and 118b without the need of the one or more university administrators knowing any custom coding or programming. The one or more university administrators enable creation of customized study abroad office websites 118a and 118b by just providing information to website modules 108a and 108b. The contents of the information provided by home universities include, but are not limited to, color and display schemes of the home university websites, logo of the home universities, policies of the home universities, information about various study abroad programs offered by home universities, type of study abroad programs that the home universities prefer for their students, relationship and/or affiliation of the home universities with one or more host universities, home university appointment schedule and home university ticketing system.

In accordance with an embodiment of the present invention, the one or more university administrators of home universities 112a and 112b provide information to website modules 108a and 108b by filing online forms through the one or more university administrator interfaces 110a and 110b.

In accordance with an embodiment of the present invention, the one or more university administrators of a home university are provided with an option of selecting one or more study abroad programs from the available study abroad programs stored in central database 104. Only the selected one or more study abroad programs are displayed on the study abroad office websites of the home university. This way the one or more university administrators may further customize the study abroad office website of their home university.

In accordance with an embodiment of the present invention, the one or more university administrators of a home university are provided with an option to input information about the study abroad programs offered by their home university.

In accordance with an embodiment of the present invention, the one or more university administrators of a home university are provided with login accounts for managing their university's study abroad office website. The one or more university administrators manage their study abroad office website by viewing the profile information of their students and the status of the various applications applied by their students for the study abroad programs.

In accordance with an embodiment of the present invention, website module 108 further creates login accounts for students of corresponding home universities in a study abroad office website created for their home universities. The students of the home universities use their login accounts for uploading, updating and viewing their profile information stored in central database 104. In accordance with another embodiment of the present invention, the one or more university administrators of a home university can create login accounts for their one or more students of their university.

In accordance with an embodiment of the present invention, one or more study abroad office websites are created such that the various study abroad programs are listed with respect to the countries. In accordance with another embodiment of the present invention, study abroad office websites are created such that the various study abroad programs are listed according to type of the programs, such as all the business programs, followed by various literature programs and so forth.

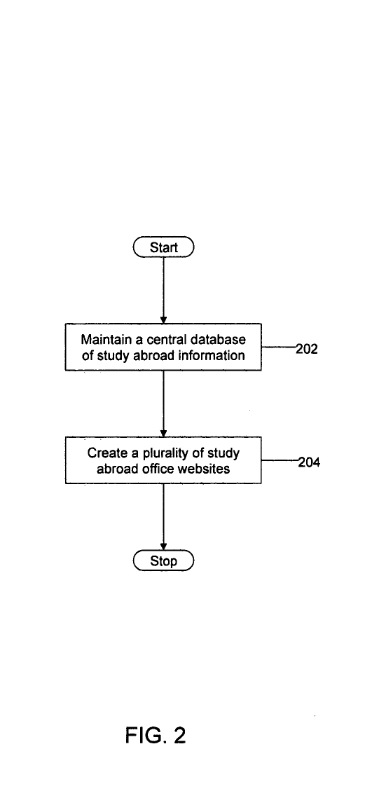

FIG. 2 is a flowchart of a method for providing customized study abroad information and assistance to students of a plurality of home universities, in accordance with an embodiment of the invention. The study abroad information is provided to students of the plurality of home universities by automatically creating study abroad office websites customized according to the needs and requirements of the plurality of home universities.

At step 202, a central database for storing the study abroad information is maintained. The study abroad information is provided by the plurality of host universities that host one or more study abroad programs. The study abroad information provided by the plurality of host universities is stored on the central database by the one or more central administrators. In accordance with an embodiment of the present invention, the one or more central administrators themselves identify the study abroad information and store the identified information on the central database. In accordance with still another embodiment of the present invention, the one or more university administrators of the plurality of home universities provide study abroad information, which is then stored on the central database. The maintained central database is used for creating a plurality of study abroad office websites for the plurality of home universities at step 204. The plurality of study abroad office websites has links to the maintained central database for the study abroad information.

In accordance with an embodiment of the present invention, a study abroad office website for a home university is created using programming languages, such as javascript, html, XML, PHP and other suitable programming languages that can implement the study abroad office website. The javascript or other suitable methods and the webpages of the created study abroad office website are dynamically generated and displayed from the central database. The study abroad office website thus created for a home university is not a static website in html. All the formatting and program options are created “on the fly” based on the customized options of the home university module relating to which host universities they have selected and how they have customized the look, feel and format of their own website. The study abroad office website is created by any one of the above described three methods, viz: via a subdomain of the website of a home university, via a subdomain of the central website which is hosted on the server of the central database described earlier or via a webpage on the central website which is hosted on the server of the central database.

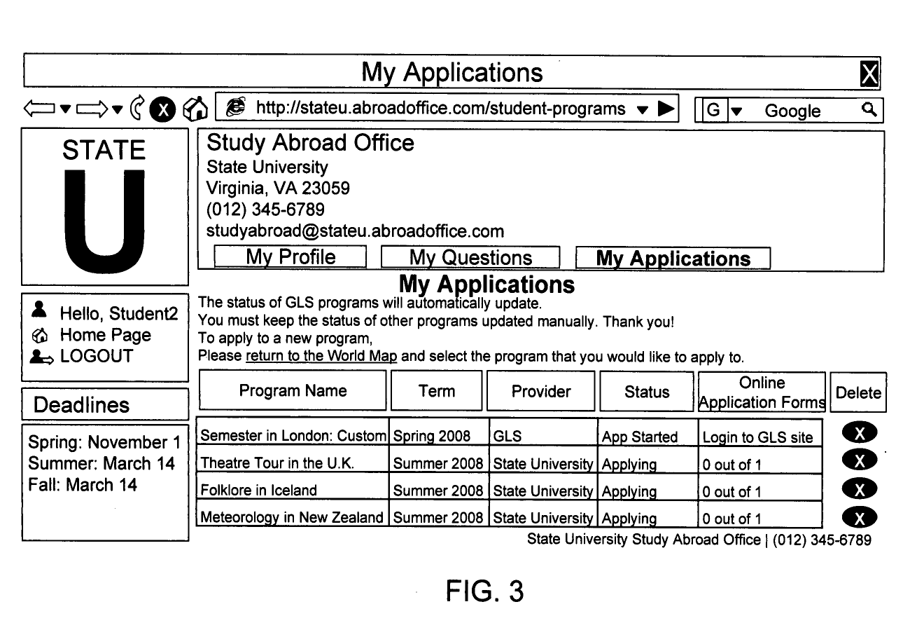

FIG. 3 is a screenshot of a webpage illustrating a login account of a student of a home university, in accordance with an embodiment of the present invention. The screenshot displays an exemplary login page of a student of State University, Virginia (home university). As shown in the screenshot, the student has various options/features in his login account, such as ‘My Profile’ for changing/updating his/her profile information, ‘My Questions’ for asking questions regarding study abroad programs and ‘My Applications’ for viewing status of his/her applications of study abroad programs. The student login account may further include other features and options obvious to a person skilled in the art.

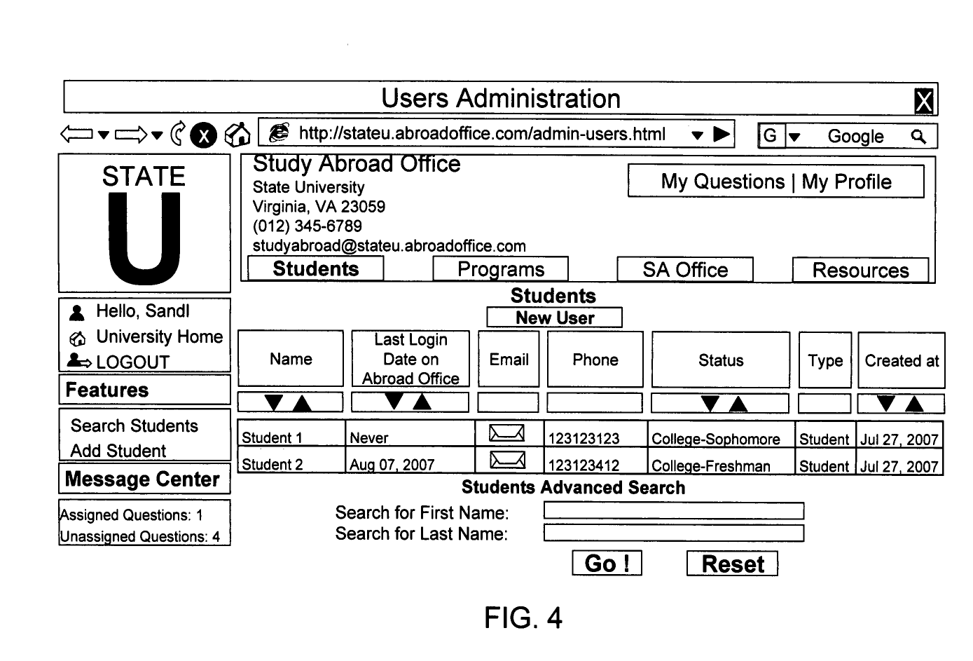

FIG. 4 is a screenshot of a webpage illustrating a university administrator login page of a study abroad office website of a home university, in accordance with an embodiment of the present invention. The screenshot displays an exemplary login page of a university administrator of State University, Virginia (home university). As shown in the screenshot, the university administrator has various options, such as ‘Students’ for managing login accounts of their university students, ‘Programs’ for adding or editing program information, ‘SA Office’ for updating details about their university study abroad office and ‘Resources’ for adding/updating information about the resources of their university. Further, the university administrator additionally has features of ‘Searching Students’ and ‘Add Student’ for adding a new login account for a student. The university administrator login account may further include other features and options obvious to a person skilled in the art.

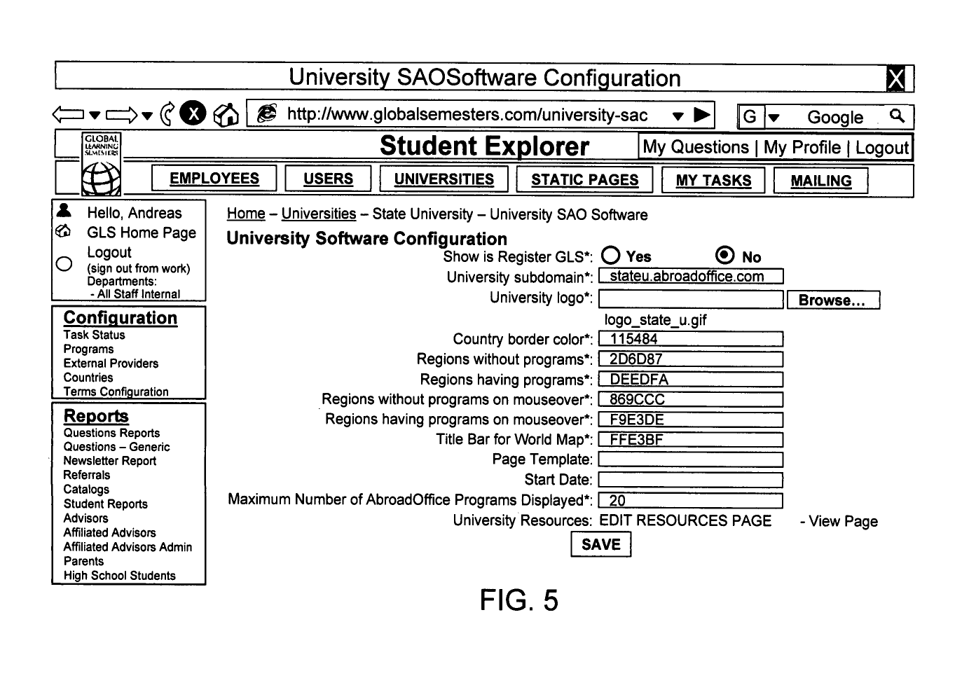

FIG. 5 is a screenshot of a webpage illustrating a central administrator login page of a central administrator in a central website, in accordance with an embodiment of the present invention. As shown in the screenshot, the central administrator has various features and options, such as adding or removing home universities, adding, editing or removing host universities, adding, editing or removing host university programs, adding, editing or removing students, customizing home university websites. The central administrator login page may further include other features and options obvious to a person skilled in the art.

In light of the various embodiments described above, the present invention provides customized and prioritized study abroad information according to the needs and requirements of the plurality of home universities. Further, the present invention enables the one or more university administrators of home universities to customize and prioritize the information in their study abroad office website without the knowledge of any custom code or programming.

The system, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer typically comprises a microprocessor. The,microprocessor is connected to a communication bus. The computer also includes a memory. The memory may include Random Access Memory (RAM) and Read Only Memory (ROM). The computer system further comprises a storage device. It can be a hard disk drive or a removable storage drive such as a floppy disk drive, optical disk drive and the like. The storage device can also be other similar means for loading computer programs or other instructions into the computer system.

The computer system executes a set of instructions that are stored in one or more storage elements in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

While the various embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for providing customized study abroad information to one or more students of a plurality of home universities in a computer network, the method comprising:
a. maintaining a central database of the study abroad information about one or more study abroad programs, wherein a plurality of host universities host one or more study abroad programs; and
b. creating a study abroad office website for a first home university of the plurality of home universities, wherein the study abroad office website is created according to the needs and requirements of the first home university, wherein the study abroad office website has links to the central database for providing the study abroad information.

2. The method of claim 1, wherein the study abroad office website is created by one or more central administrators of the central database.

3. The method of claim 2, wherein the one or more central administrators customize the study abroad office website according to the needs and requirements of the first home university.

4. The method of claim 3, wherein the first home university provides information about itself to the central database for the creation of the study abroad office website.

5. The method of claim 4, wherein the one or more central administrators customize the study abroad office website based on the information provided by the first home university.

6. The method of claim 1, wherein one or more central administrators regularly update the central database with the latest study abroad information.

7. The method of claim 1, wherein one or more central administrators manage the study abroad information stored in the central database.

8. The method of claim 1, wherein the study abroad office website is managed by one or more first home university administrators.

9. The method of claim 8, wherein the one or more university administrators add programs of the first home university in the study abroad office website.

10. The method of claim 8, wherein the one or more university administrators create login accounts in the study abroad office website for their one or more students.

11. The method of claim 10, wherein the one or more students use their login accounts for applying to various study abroad programs.

12. The method of claim 1, wherein the study abroad office website is dynamically created.

13. A system for providing customized study abroad information to one or more students of a plurality of home universities in a computer network, the system comprising:
a. a central database for storing the study abroad information about one or more study abroad programs, wherein a plurality of host universities host one or more study abroad programs;
b. a main administrator interface for managing the study abroad information stored on the central database; and
c. a plurality of website modules connected to the central database for creating a plurality of study abroad office websites for the plurality of home universities, wherein one study abroad office website is created for each of the plurality of home universities, and wherein the plurality of study abroad office websites are linked to the central database.

14. The system of claim 13 further comprising a plurality of university administrator interfaces connected to the plurality of website modules, wherein the plurality of university administrator interfaces are used for managing the plurality of study abroad office websites, and wherein one university administrator interface is connected to one website module for managing study abroad office website of a first home university.

15. The system of claim 14, wherein one or more university administrators of the first home university have access to the study abroad office website of the first home university through the university administrator interface.

16. A computer program product for providing customized study abroad information to one or more students of a plurality of home universities in a computer network, the computer program product comprising a computer readable medium comprising:
a. program instructions for maintaining a central database of the study abroad information about one or more study abroad programs, wherein a plurality of host universities host one or more study abroad programs; and
b. program instructions for creating a study abroad office website for a first home university of the plurality of home universities, wherein the study abroad office website is created according to the needs and requirements of the first home university, and wherein the study abroad office website has links to the central database for providing the study abroad information.
